(19) United States
(12) Patent Application Publication
(10) Pub. No.: US 2007/0159753 A1
(43) Pub. Date: Jul. 12, 2007

(54) System for EMI/RFI filtering and transient voltage suppression

(76) Inventors: Michael Steven Randall, Simpsonville, SC (US); Corey Antoniades, Seneca, SC (US)

Correspondence Address: ALMEGACY LLC., 313 River Walk Drive, Simpsonville, SC, 29681, US

(21) Appl. No.: 11/327,931

(22) Filed: Jan. 9, 2006

(51) Int. Cl. H02H 3/22

(52) U.S. Cl. 361/111

(57) ABSTRACT

A woven or interlaced electronic system for electronic EMI/RFI (Electromagnetic Interference/Radio Frequency Interference) filtering and for Transient Voltage Suppression. This filtering system consists of two diverse types of flexible and electrically conductive wires that are woven or interlaced into a fabric through the use of textile technologies and/or practices. The primary wire is a flexible or bendable, conductive core, single or double clad, edifice which promotes one direction of electron flow across the woven material (the “warp” of the fabric). The succeeding wire 12 is of a conventional, flexible, single or multiple strands, non-insulated type which promotes a divergent direction of electron flow across the woven material (the “weft” of the fabric).

### BACKGROUND OF THE INVENTION

The present invention is related to a Provisional Patent Ser. No. 60/642,491 filed Jan. 10, 2005, which relates to an electronic device comprised of a woven or interlaced structure of composite and/or non-composite conductive wire assemblies that may be used without a substrate, or with a flexible substrate or mounted onto, or imbedded within, a rigid circuit board or an electronic substrate and a method of manufacture thereof, and particularly relates to an electronic device of a woven or interlaced structure that is to be used mainly for the filtering of Electromagnetic interference (EMI), Radio Frequency Interference (RFI) and/or transient voltage suppression, and a method of manufacturing such a device.

With the progress of scientific technologies, the making of electronic equipment more compact and higher in performance is being demanded. As systems shrink in size, become more compact and portable, and more networked/interconnected, EMC (electromagnetic compatibility) is of huge concern to overall system performance. EMC means that the device is compatible with (i.e., no interference caused by) its electromagnetic (EM) environment and it does not emit levels of EM energy that cause EMI (electromagnetic interference) in other devices in the vicinity. EMI is any electrical disturbance that interferes with normal operation of electronic equipment. Sources of EMI include cell phones, computers, transmitters, system clocks, data lines, oscillators, receiver local oscillators, voltage regulators, power lines, motors, switching circuits, etc. Broadly speaking, all high-speed digital signals can be a source of EMI. Additionally, transient voltage suppression (TVS) is also a concern. A transient system is a short-lived voltage oscillation in a system caused by a sudden change of voltage, current, or load. One example of a transient is electrostatic discharge. Increased electronic system densities and speed have led to a concern of electrical overstress, especially due to ESD. These performance gains are due to the giant strides made in integrated circuit complexity and the resulting smaller device sizes. Internal protection devices built into integrated circuits have been reduced in size to minimize their impact on speed and circuit area. This trend has lead to increased ESD sensitivity in said electronic devices. External protection is now required at system inputs and outputs to eliminate overstress damage and surface mount technology (SMT) is now placing severe size constraints on components in addition to providing protection.

Electromagnetic interference (EMI) filters come in many shapes and forms and are typically designed such that the desired frequencies bypass ground and are conducted to the device, while unwanted frequencies or EMI noise are absorbed and/or conducted away from the device and to ground. EMI filters come in several form factors and are configured to include at least one capacitor element that is connected between the signal edge and ground. Additional EMI configurations may include inductive or resistive element/s or combinations thereof in order to maximize filter performance.

When considering transient voltage suppression, most transients are low voltage events which can be attenuated enough by the conventional EMI/RFI filter. Excessive transient voltage events, such as ESD, EMP (electromagnetic pulse) and electrical voltage surges, due to lightning or the like, demand a semiconductor device, such as a varistor, to protect the circuit from voltage transients. When connected between the signal edge and ground and the transient does not exceed the design voltage of the varistor, the electrical characteristics of the varistor are similar to that of a capacitor. However, when the transient exceeds the design voltage of the varistor, the impedance across the varistor decreases sharply and instantaneously, thereby enabling conductance of the transient to ground.

Numerous devices have been disclosed for electronic filtering applications including U.S. Pat. Nos. 6,721,171; 6,873,518; and 6,388,863, as well as published patent application number U.S. 2004/0021534. These devices are directed to various inflexible types of noise filters that are restricted by design, application and interconnect ability. There has been a ongoing effort to provide a device that is compact and flexible in design and application, wherein any interconnect requirement can be provided as well as an improved devise density capability and excellent volumetric efficiency over conventional filtering devices

### SUMMARY OF THE INVENTION

It is an object of the present invention to provide an electronic device of a woven or interlaced structure that will mainly be used for the filtering of (EMI) Electromagnetic interference and/or (RFI) Radio Frequency interference and/or transient voltage suppression (TVS).

It is another object of the present invention to provide an EMI/RFI filtering device and/or transient voltage surge suppression device in a compact and flexible

It is yet another object of this invention to provide an electronic device that can be embedded or incorporated in fabrics or clothing as well as in electronic equipment that requires high density, flexible interconnects.

It is yet another object of this invention to provide an electronic device that may be assembled through the use of textile technologies, enabling inexpensive, high volume manufacturing of a very high input/output density device.

A particular feature of the present invention is the ability to be a mechanically flexible or bendable structure.

Another particular feature of the present invention is the ability to be designed and manufactured to meet any interconnect requirement (wire count per unit length).

A particular advantage of the present invention is the ability of the device to act as a faraday cage in the company of a suitable design, enabling an additional dimension of electromagnetic noise isolation.

Another particular advantage of the present invention is the ability to have improved device density capability and excellent volumetric efficiency over conventional EMI/RFI and transient voltage suppression devices.

These and other advantages are provided in a device comprising of two diverse types of flexible and electrically conductive wires that are woven or interlaced in a non-lateral configuration. The primary wire is a flexible and/or bendable, conductive core, double clad, edifice which promotes one direction of electron flow across the device. The succeeding wire is of a conventional, flexible, single or multiple strands, non insulated type which promotes a divergent direction of electron flow across the device.

The primary wire is a nano-composite consisting of a core-clad-clad structure. The core of the wire is comprised of a flexible conductor material that acts as the transmission structure. The inner clad of the primary wire is comprised of a dielectric or ferrite material formed or deposited suitably on the surface of the largely conductive core in the case of EMI filtering, or is comprised of a varistor material formed on the core in the case of transient voltage suppression. The outer clad of the primary wire is comprised of an electrically conductive layer which is formed over the dielectric in order to sandwich the dielectric, ferrite, or varistor material between the conductive core and the outer clad.

During assembly, the primary wire is woven or interlaced with a secondary wire, a conventional, non-insulated conductive wire. The primary wire provides the warp of the woven or interlaced device, while the secondary wire provides the weft of the woven or interlaced device. The warp of the device is connected between the signal-line via the conductive cores, while the weft is connected to a common ground. As a result of the two wires being woven or interlaced together the conventional conductive wire comes into contact with the outer conductive clad of the primary wire in at least one incident, providing an electrically conductive earthing path.

During EMI filtering, electric signals input into the primary wire conductive core can be filtered by means of the dielectric layer and the conductive layer over a wide frequency range and can therefore conduct unwanted frequencies or EMI noise away from the device and to ground. During a transient voltage suppression event, a voltage transient follows the electrical path to ground as in the EMI filtering device when the transient exceeds the design voltage of the varistor inner clad material of the primary wire. The impedance the varistor inner clad material decreases sharply and instantaneously, thereby enabling conductance of the transient to the earthing path provided by the secondary wire.

### DESCRIPTIONS OF THE DRAWINGS

Embodiments of this invention are described with reference to the accompanying diagrammatic drawings, in which:

FIG. 1 is a perspective view of a flexible, woven or interlaced, electronic filtering system for electronic EMI/RFI filtering and/or transient voltage suppression according to the embodiment of this invention.

FIG. 2 shows a plan view of the same device as FIG. 1

FIG. 3 is a sectional view of the composite primary wire structure according to the embodiments of this invention.

FIG. 4 is a sectional view of the non-composite secondary wire according to the embodiments of this invention.

FIG. 5 illustrates the device used in a noise filtering application.

FIG. 6 illustrates the device used in a transient voltage suppression application.

FIG. 7 is a perspective view, showing the device in multiple layers.

### DETAILED DESCRIPTION OF THE INVENTION

FIGS. 1 and 2 are perspective views of a flexible, woven or interlaced, electronic system for electronic EMI/RFI (Electromagnetic Interference/Radio Frequency Interference) filtering and for Transient Voltage Suppression. This filtering system consists of two diverse types of flexible and electrically conductive wires that are woven or interlaced into a fabric through the use of textile technologies and/or practices. The primary wire 11 is a flexible or bendable, conductive core, double clad, edifice which promotes one direction of electron flow across the woven material (the “warp” of the fabric). The succeeding wire 12 is of a conventional, flexible, single or multiple strands, non-insulated type which promotes a divergent direction of electron flow across the woven material (the “weft” of the fabric). Variation in weave or interlacement pattern, design, and wire count per unit length (I/O or input/output or strand density) are determined by design and are dependent upon product application and/or the desired electrical characteristics of the fabric.

FIG. 3 is a perspective view of the primary wire 11. The primary wire is a conductive core, double clad, edifice constructed in accordance with the invention. The core of the wire 13 consists of a highly conductive, single or multiple strand, flexible or bendable material which may include but is not limited to Cu, Al, Ni, Ti, Ta, Nb or alloys thereof. The conductive core may vary in size, shape, cross-section and/or geometry depending upon product application and desired electrical characteristics of the fabric.

The inner clad (insulating clad) 14 is comprised of a flexible or bendable and fully insulating, dielectric, varistor, or ferrite (magnetic) material/s or combination thereof. Potential dielectric materials include, but are not limited to Aluminum oxide, Barium titanate, titania, tantalum pentoxide, and niobium pentoxide. Formation of the inner clad material over the conductive core may include but is not limited to methods of electrophoretic deposition, Sol-Gel deposition, anodization or the like. Selection of the inner clad material or combinations thereof is determined by product application and/or desired electrical characteristics of the resulting fabric. Product application and/or desired electrical characteristics of the fabric also define the ensuing material thicknesses, shapes and /or geometries.

The outer clad 15 consists of a highly conductive, flexible of bendable material. Electrically conductive materials include, but are not limited to Ni, Cu, Al, Ag, Au and/or a conductive polymer material such as polypyrrole or the like. Formation of conductive material over the inner clad 14 may include but is not limited to methods of chemical attachment, electroless plating, vacuum plating, electrophoretic deposition or interlacement of conductive materials. Product application and/or desired electrical characteristics of the fabric ascertain the necessity of outer clad 15 as well as selection, method of application, and thickness of said material/s.

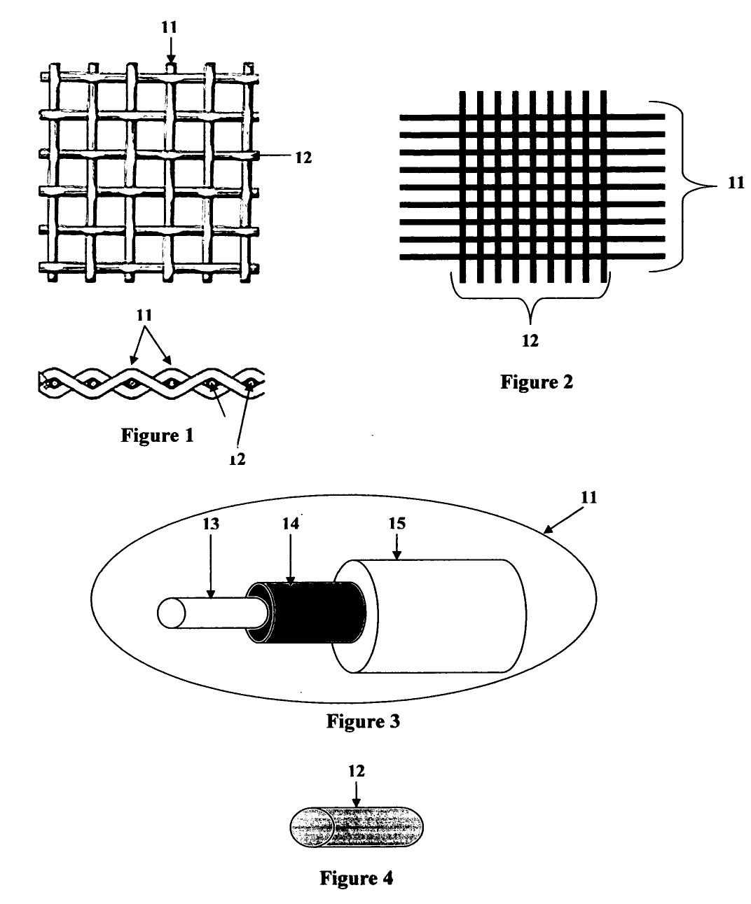

FIG. 4 is a perspective view of the succeeding wire 12. The succeeding wire is of a conventional, flexible or bendable, single or multiple strand, non-insulated type which may be composed of but is not limited to Cu, Al, Au, Ag, Ni, Ti, Ta, Nb or the like and /or alloys thereof. This conductive wire may vary in size, shape, and/or geometry depending upon product application and desired electrical characteristics of the fabric.

Depending upon application, post weave immersion of the fabric in a conductive polymer, liquid solder, or the like, may be desirable to improve electronic filtering characteristics and/or to complete the assembly process.

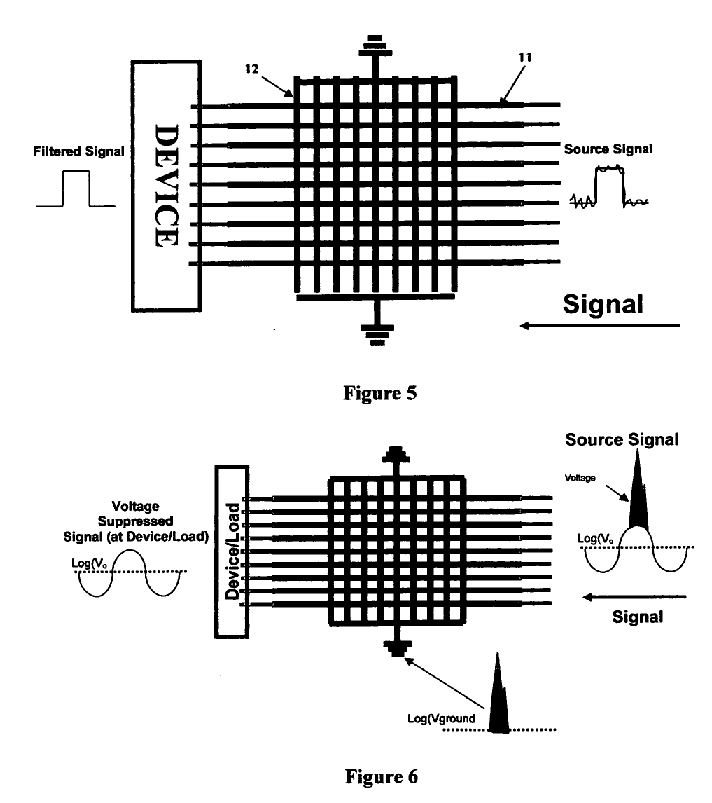

In operation one uses this filtering system as a single or multiple interconnect EMI/RFI filter and/or Transient Voltage suppressor. As a result of the two wires being woven or interlaced together the conventional conductive wire (secondary wire) comes into contact with the outer conductive clad of the primary wire in at least one incident, providing an electrically conductive earthing path. Upon introduction to a circuit, device, and/or interconnect structure; the conductive core of the double clad wire system 11 is used as the signal interconnect line, while the conductor wire 12 is used as a ground interconnect line (FIG. 5).

In an EMI/RFI filter application this filtering system eliminates unwanted voltage variation (electronic noise) by diverting the unwanted electronic signal or energy away from the protected system or load. Due to the versatility of the design of the primary wire 11, variations of inner core material (dielectric and ferrite) allows for design flexibility. This flexibility allows for alternative electrical characteristics of the fabric. Upon using a dielectric as the inner clad material 14 of the primary wire 11, the electrical characteristic of the fabric is similar to that of a capacitor. As the signal frequency increases the impedance of the fabric decreases, thus more of the noise is shunted to ground thru the secondary wires 12. When using a ferrite material, or mixture thereof, the electrical characteristics would be similar to that of an inductor. As the signal frequency increases the impedance of the fabric increases and either reflects or absorbs the noise thus preventing noise from continuing down the signal lines 11 or enabling a significant portion of the lower frequency electronic current to be shunted to ground. Varying combinations of primary wire, with assorted 11 inner clad materials, grouped in the warp and/or grouped in the weft in conjunction with the secondary wire of the woven or interlaced device, will promote alternative EMI filter circuit designs in any given system which include but are not limited to C, L, T, Pi and multi-element EMI/RFI filters. The fabric is also bi-directional by means of keeping unwanted noise out of the system and preventing that system from emitting noise.

In a transient voltage suppression application, most transients are low voltage events which can be attenuated enough by the conventional EMI/RFI filter cloth designs. Seriously high voltage events, such as ESD (electrostatic discharge), EMP (electromagnetic pulses) and electrical voltage surges, due to lightening or the like, demand a varistor or suitable dielectric inner core 14 material of the primary wire 11. When the voltage surge does not exceed the design voltage of the fabric, the electrical characteristic of the fabric is similar to that of a capacitor. However, when the surge voltage exceeds the design voltage of the fabric during operation, the impedance across the fabric decreases sharply and instantaneously, thereby enabling conductance of the voltage spike to ground, protecting the circuitry subsequent to the woven interconnect system described. Since input voltage to the protected system depends on the internal resistance and line impedance of the fabric, the decrease in the impedance across the fabric allows surge voltage suppression to ground as described (FIG. 6).

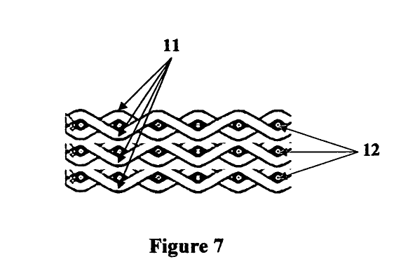

The advantages of this filtering system are numerous. Since this is essentially a fabric, the filter pin count per unit length (I/O density) can be very high, exceeding 500 structures per linear inch of fabric. Additionally, the woven fabric is flexible and/or bendable, which facilitates use in flexible circuitry, interconnects and the like. Furthermore, the fabric may be embedded in circuit boards (FR4 or the like) in single or multiple layers of functionality (FIG. 7). This additionally enables multiple filtering capabilities in one board such as EMI/RFI filtering combined with transient voltage suppression.

1. A device for EMI/RFI filtering and/or transient voltage suppression comprising:
a primary wire/s constituted of an electrically conductive core and an insulating layer consisting of a dielectric, ferrite, or varistor material which is fashioned to sheath the conductive core, and a conductive outer layer which is fashioned to sheath the insulating layer in order to sandwich the insulating layer between the core and the outer conductive layer: and
a secondary conductive, non-insulated wire/s which is woven or interlaced in a non-lateral configuration with the primary wire/s such that the primary wire/s forms the warp of the woven or interlaced device while the secondary wire/s forms the weft of the woven or interlaced device, wherein the conductive secondary wire/s comes into contact with the outer conductive layer of the primary wire/s in at least one incident, and wherein the conductive core of the primary wire/s acts as the signal path and provides for one direction of electron flow across the device while the secondary wire/s provides an electrically conductive earthing path and/or a divergent direction of electron flow across the device.

2. The device in claim 1 where the conductive core of the primary wire has a cross-section characterized by a simple or complex geometric form and/or shape.

3. The device in claim 1 where the primary wire has a cross-section characterized by a non-geometrical or irregular form and/or shape.

4. The device in claim 1 where the secondary wire has a cross-section characterized by a simple or complex geometric form and/or shape.

5. The device in claim 1 where the secondary wire has a cross-section characterized by a non-geometrical or irregular form and/or shape.

6. The device in claim 1 where the conductive core of the primary wire is comprised of Nb, Al, Ti, Ta, W, Mo, Cu, Pd, Pt, Au, Ag, Rh, Ni, Cr, or any mixture or alloy thereof, or any composite mixed with any other conductive, resistive or inductive material thereof.

7. The device in claim 1 where the secondary wire is comprised of Nb, Al, Ti, Ta, W, Mo, Cu, Pd, Pt, Au, Ag, Rh, Ni, Cr, or any mixture or alloy thereof.

8. The device in claim 1 where the insulating layer of the primary wire is comprised of titania, barium titanate, tantalum pentoxide, niobium pentoxide, alumina, silica, zinc oxide, nickel oxide, any of the oxides of tungsten, doped zinc oxide, doped barium titanate or any combination thereof.

9. The device in claim 1 where the outer conductive layer of the primary wire is comprised of Nb, Al, Ti, Ta, W, Mo, Cu, Pd, Pt, Au, Ag, Rh, Ni, Cr, or any mixture or alloy or composite thereof.

10. The device in claim 1 where the outer conductive layer of the primary wire is comprised of Nb, Al, Ti, Ta, W, Mo, Cu, Pd, Pt, Au, Ag, Rh, Ni, Cr, or any mixture or alloy or composite thereof mixed with an oxide or inter-metallic.

11. The device in claim 1 where the outer conductive layer of the primary wire is comprised of Nb, Al, Ti, Ta, W, Mo, Cu, Pd, Pt, Au, Ag, Rh, Ni, Cr, or any mixture or alloy or composite thereof mixed with a conductive polymer or other conductive material.

12. The device in claim 1 where either the inner conductive core, or the outer conductive layer or both of the primary wire is/are comprised of a superconducting material or a mixture, alloy or composite of a superconducting material and Nb, Al, Ti, Ta, W, Mo, Cu, Pd, Pt, Au, Ag, Rh, Ni, Cr, or any mixture or alloy or composite thereof.

13. The device in claim 1 where the outer conductive layer of the primary wire is comprised of a conductive polymer such as but not limited to polypyrole, polythiophene or polyaniline or any combination of conductive polymers.

14. The device in claim 1 where the woven structure comprises inductor beads over the primary wire in the woven structure.

15. The device in claim 1 wherein the interlaced structure comprises inductor beads over the primary wire in the interlaced structure.

16. The device in claim 1 contained in an electronic circuit board.

17. The device in claim 1 contained in an electronic package.

18. The device in claim 1 contained in a flexible electronic circuit.

19. The device in claim 1 impregnated with any conductive material such as, but not limited to a conductive polymer, or a metal matrix-organic composite or the like.

20. The device in claim 1 contained in a woven textile.

21. The device in claim 1 comprising a three dimensional multiple layer woven structure.

22. The device in claim 21 having vertical interconnection between the woven or interlaced layers.

23. The device in claim 1 and 21 containing a tertiary wire with resistive, inductive or capacitive electrical properties in conjunction with the primary and/or secondary wire/s.

24. The device in claim 1 used as a Faraday cage and/or a Tempest shield.
